(19) United States
(12) Patent Application Publication
(10) Pub. No.: US 2010/0205429 A1
(43) Pub. Date: Aug. 12, 2010

(54) SYSTEM AND METHOD FOR VERIFYING THAT A REMOTE DEVICE IS A TRUSTED ENTITY

(75) Inventors: ANSAF I. ALRABADY, LIVONIA, MI (US); DAVID RACKLYEFT, TROY, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/368,511

(22) Filed: Feb. 10, 2009

(51) Int. Cl. H04L 9/00

(52) U.S. Cl. 713/156

(57) ABSTRACT

Methods and systems are provided for verifying that a remote device is a trusted entity. The method comprises receiving a first digital certificate from a first certificate authority, wherein the first certificate authority is a trusted entity, receiving a second digital certificate from the remote device during a first handshake procedure for establishing a secure connection, the second digital certificate corresponding to a second certificate authority, determining if the second digital certificate was issued by the first certificate authority based on at least a portion of the contents of the first digital certificate, and storing the second digital certificate to enable subsequent authentication of additional digital certificates received from the remote device, if the second digital certificate was issued by the first certificate authority.

### TECHNICAL FIELD

The present invention generally relates to electronic communication, and more particularly relates to a system and method for verifying that a remote device is a trusted entity.

### BACKGROUND OF THE INVENTION

Increasingly, vehicles are configured with vehicular communications systems (VCSs) that enable them to communicate with one or more remote devices via an electronic network. For example, a VCS may communicate with an Internet server, or other network server, that is controlled by the manufacturer of the vehicle or another trusted entity. The network server may communicate with the vehicle in order to retrieve information regarding the operational status of the vehicle, enable certain features on the vehicle, and/or provision the vehicle with additional features. The speed and amount of data transmitted and received by the VCS during such transmissions may be limited due to the capacity of the VCS and the inherent difficulties involved with communicating via a wireless network that is designed to cover great distances.

In order to protect this information, a secure communication protocol may be used to enable the VCS to verify that the network server is a trusted entity. One method for providing such verification involves the use of a public key infrastructure. The public key infrastructure provides a trusted certificate authority that issues credentials to the VCS and the network server. Under this scheme, the network server transmits its credential to the VCS during the creation of a secure connection between both devices. The VCS is then able to verify that the network server is a trusted entity.

However, the trusted certificate authority must be replaced when its security of the public key infrastructure is compromised. For example, a malicious third-party may illegitimately obtain a private key of the trusted certificate authority and use that private key to generate a credential. The malicious third-party may then use that credential to communicate with the VCS. Under such circumstances the only way to restore the security within the public key infrastructure is to replace the certificate authority and the credentials that it issued. This process requires that each VCS be updated with credentials for the new certificate authority resulting in significant time and expense for the manufacturer of the vehicle.

One method for protecting the integrity of the trusted key certificate authority is to utilize a hierarchical public key infrastructure. Under a hierarchical public key infrastructure, the trusted certificate authority issues credentials to a subordinate certificate authority and to the VCS. The trusted certificate authority can then be kept off-line and highly secure, enabling its private key to be highly protected. The subordinate certificate authority then issues a credential to the network server. During the creation of a secure connection, the network server transmits both its credential and the credential for the subordinate certificate authority to the VCS, enabling the VCS to verify that the network server is a trusted entity.

Under this scheme, if a malicious third-party obtains the private key of the subordinate certificate authority (e.g., to pose as a trusted network server), the security of the hierarchical public key infrastructure can be restored by replacing the subordinate certificate authority and the credential that it issued to the network server. This process is substantially less expensive to the manufacturer of the vehicle because it does not require replacing information stored on the VCS. However, the hierarchical public key infrastructure requires the network server to transmit multiple credentials to the VCS for each secure connection. Further, given the bandwidth limitations between the VCS and the network server, transmitting multiple credentials for each secure connection can significantly impact the performance of both devices.

Accordingly, it is desirable to provide a method that enables a VCS and a network server to utilize a hierarchical public key infrastructure without requiring the remote device to transmit multiple credentials. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

A method is provided for verifying that a remote device is a trusted entity. The method comprises receiving a first digital certificate from a first certificate authority, wherein the first certificate authority is a trusted entity, receiving a second digital certificate from the remote device during a first handshake procedure for establishing a secure connection, the second digital certificate corresponding to a second certificate authority, determining if the second digital certificate was issued by the first certificate authority based on at least a portion of the contents of the first digital certificate, and storing the second digital certificate to enable subsequent authentication of additional digital certificates received from the remote device, if the second digital certificate was issued by the first certificate authority.

In another embodiment, a vehicular communication system for establishing a secure connection with a remote device is provided. The vehicular communication system comprises a wireless transceiver for communicating with the remote device, electronic memory having a first digital certificate issued by a first certificate authority stored thereon, wherein the first certificate authority is a trusted entity, and a processor coupled to the wireless transceiver and the electronic memory. The processor is configured to receive a second digital certificate from the remote device during a handshake procedure for establishing the secure connection, the second digital certificate corresponding to a second certificate authority, receive a third digital certificate from the remote device during the handshake procedure, the third digital certificate corresponding to the remote device, determine if the second digital certificate was issued by the first certificate authority based on at least a portion of the contents of the first digital certificate, determine if the third digital certificate was issued by the second certificate authority based on at least a portion of the contents of the second digital certificate, and store the second digital certificate to enable subsequent authentication of additional digital certificates received from the remote device, if the second digital certificate was issued by the first certificate authority and the third digital certificate was issued by the second certificate authority.

### DESCRIPTION OF THE DRAWINGS

The present invention will hereinafter be described in conjunction with the following drawing figures, wherein like numerals denote like elements, and

FIG. 1 is a depiction of an exemplary vehicle configured for use with one embodiment of the present invention;

FIG. 2 is a block diagram of an exemplary system for establishing a secure connection between a vehicular communication system and a remote device;

FIG. 3 is a flow chart of an exemplary method for receiving a public key certificate for a subordinate certificate authority and a public key certificate for a remote device during a handshake procedure for establishing a secure connection; and

FIG. 4 is a flow chart of an exemplary method for receiving only the public key certificate for a remote device during a handshake procedure for establishing a secure connection.

### DESCRIPTION OF AN EXEMPLARY EMBODIMENT

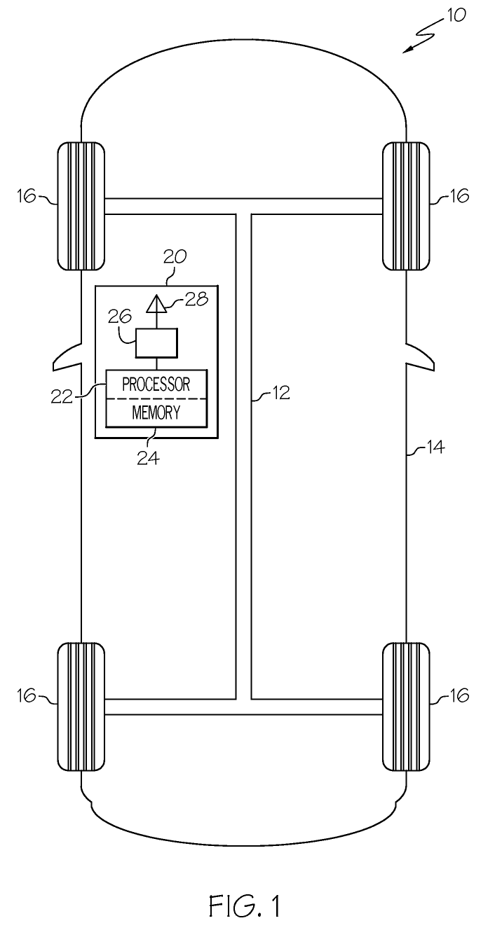

The following detailed description is merely exemplary in nature and is not intended to limit the invention or the application and uses of the invention. Furthermore, there is no intention to be bound by any expressed or implied theory presented in the preceding technical field, background, brief summary or the following detailed description. It should also be understood that FIGS. 1-4 are merely illustrative and, particularly with respect to FIG. 1, may not be drawn to scale.

FIG. 1 is a depiction of an exemplary vehicle 10 configured for use with one embodiment. The vehicle 10 includes a chassis 12, a body 14, four wheels 16 and a vehicle communication system (VCS) 20. The body 14 is arranged on the chassis 12 and substantially encloses the other components of the vehicle 10. The body 14 and the chassis 12 may jointly form a frame. The wheels 16 are each rotationally coupled to the chassis 12 near a respective corner of the body 14.

The vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The vehicle 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the illustrated embodiment, the VCS 20 includes a processor 22, memory 24, and a wireless transceiver 26. As used herein, the term “processor” may refer to a programmable logic control system (PLC), a microprocessor, or any other type of electronic controller. Further, a “processor” may include one or more components of a digital and/or analog type and may be programmable by software and/or firmware. In addition, as used herein the term “memory” may refer to electronic memory (e.g., ROM, RAM, or another form of electronic memory) and stores instructions and/or data in any format, including source or object code. As further described below, processor 22 is configured to authenticate and store digital certificates that it receives from a remote device.

The wireless transceiver 26 is coupled to a wireless antenna 28 and enables wireless communications between the VCS 20 and an electronic network via a wireless network access point. For example, in one embodiment the wireless transceiver 26 includes a short range wireless communication device that communicates with a wireless router or other short range network communication device. Further, the wireless transceiver 26 may include a cellular modem that is coupled to a cellular phone. In this case, the cellular phone connects the wireless modem to an Internet Service Provided (ISP) modem or other telephonic network access point. It should be noted that in other embodiments, other wireless communication technologies (including satellite) may also be used.

Although the illustrated embodiment depicts a vehicular communication system (e.g., VCS 20), it will be understood by one who is skilled in the art that alternative embodiments of the present invention may utilize other electronic devices as well. Such electronic devices may include a personal computer (e.g., a laptop), a Personal Digital Assistant (PDA), a cell phone, or any other electronic device having an electronic communication interface for receiving data via an electronic network and a processor for generating the digital certificates and other cryptographic elements described below.

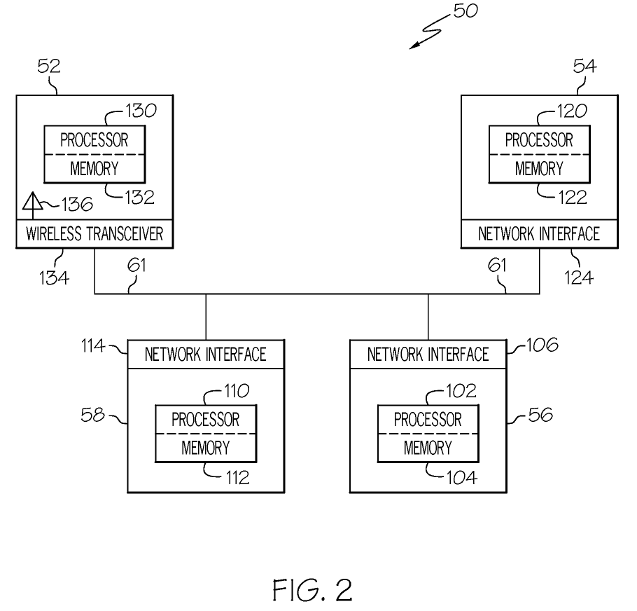

FIG. 2 is a block diagram of an exemplary system 50 for establishing a secure connection between a VCS 52 and a remote device 54. System 50 of FIG. 2 comprises a hierarchical public key infrastructure that includes VCS 52, remote device 54, a trusted root certificate authority 56, and a subordinate certificate authority 58. Each of these devices is configured to communicate via an electronic network 61 or other communication medium.

As further described below, within the hierarchical public key infrastructure of system 50 trusted root certificate authority 56 issues a public key certificate to subordinate certificate authority, enabling VCS 52 to verify that subordinate certificate authority 58 is a trusted entity. Further, the subordinate certificate authority 58 issues a public key certificate to remote device 54, enabling VCS 52 to verify that remote device 54 is also a trusted entity. Thus, the hierarchical public key infrastructure enables a chain of trust to be established between trusted root certificate authority 56 and remote device 54, enabling VCS 52 to establish a secure connection with remote device 52.

Trusted root certificate authority 56 is maintained by a trusted third party and configured to issue a root certificate and a plurality of public key certificates. As depicted, trusted root certificate authority 56 includes a processor 102, memory 104, and a network interface 106. The network interface 106 enables the trusted root certificate authority 56 to communicate with other devices via the electronic network 61.

Trusted root certificate authority 56 issues a root certificate to VCS 52. The root certificate includes a public key (hereinafter the “CA public key”) that mathematically corresponds to a private key (hereinafter the “CA private key”) stored in memory 104. In addition, the root certificate includes a digital signature that is generated with the CA private key. As described below, the root certificate enables VCS 52, and in some cases remote device 54, to authenticate public key certificates that are issued by trusted root certificate authority 56. The root certificate may be installed on VCS 52 during the production process of the vehicle (e.g., vehicle 10 of FIG. 1) or by a secure data transfer technique.

Trusted root certificate authority 56 also issues public key certificates (hereinafter “sub-CA certificates”) to one or more subordinate certificate authorities (e.g., subordinate certificate authority 58). For example, trusted root certificate authority 56 may issue a first sub-CA certificate to subordinate certificate authority 58 for the purpose of establishing a secure connection between VCS 52 and remote device 54. Trusted root certificate authority 56 may subsequently issue a newer sub-CA certificate to another subordinate certificate authority, for the purpose of revoking the first sub-CA certificate. Trusted root certificate authority 56 may issue the newer sub-CA certificate for a plurality of reasons, such as an expiration of the first sub-CA certificate or the belief that subordinate certificate authority 58 is compromised. The sub-CA certificates may be transmitted to the subordinate certificate authority via electronic network 61 or other secure data transfer technique.

Each sub-CA certificate comprises the public key for the subordinate certificate authority (hereinafter the “sub-CA public key”), a serial value, and a digital signature. The sub-CA public key mathematically corresponds to a private key that is stored on the subordinate certificate authority (hereinafter the “sub-CA private key”). The digital signature is generated with the CA private key and enables any entity (e.g., the VCS 52) having the root certificate for trusted root certificate authority 56 (and the CA public key that is stored within the root certificate) to verify that the sub-CA certificate was issued by trusted root certificate authority 56. The serial value is a unique value that distinguishes the public key certificate from other public key certificates generated by the trusted root certificate authority 56. The trusted root certificate authority 56 increments the serial value each time that it generates a sub-CA certificate. Thus, a sub-CA certificate will always have a larger serial value than sub-CA certificates generated at an earlier time.

Subordinate certificate authority 58 is also maintained by a trusted entity and is configured to receive sub-CA certificates from trusted root certificate authority 56. In addition, subordinate certificate authority 58 provides public key certificates to one or more remote devices (e.g., remote device 54). As depicted, subordinate certificate authority 58 includes a processor 110, memory 112, and a network interface 114. The network interface 114 enables the subordinate certificate authority 58 to communicate with other devices, such as remote device 54, via the electronic network 61.

Subordinate certificate authority 58 receives and stores the sub-CA certificate issued by trusted root certificate authority 56. As described above, the sub-CA certificate includes a sub-CA public key that mathematically corresponds to a sub-CA private key stored in memory 112, a serial value, and a digital signature. In addition, subordinate certificate authority 58 generates and provides a public key certificate for the remote device 54 (hereinafter the “remote device certificate”). The remote device certificate comprises a public key for the remote device (hereinafter the “remote device public key”) and a digital signature. The remote device public key mathematically corresponds to a private key (hereinafter the “remote device private key”) that is stored on the remote device 54. The digital signature is generated with the sub-CA private key.

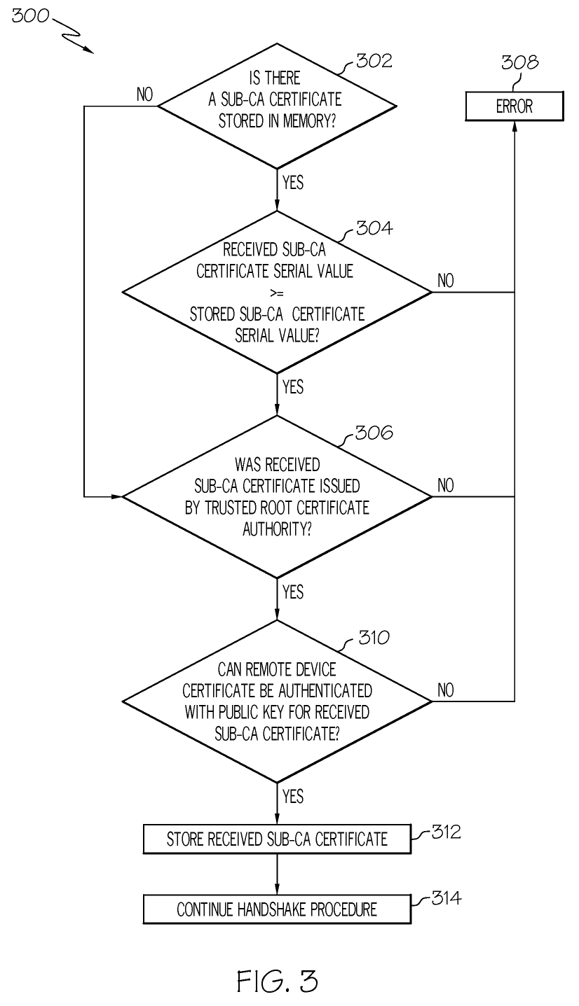

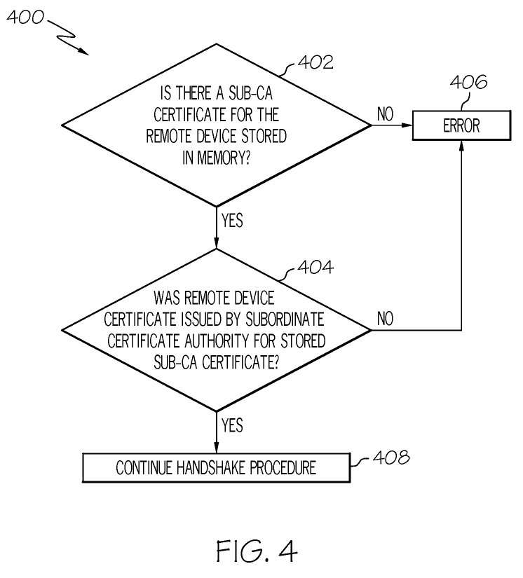

Remote device 54 may be any electronic device capable of establishing a secure connection with the VCS 52. In one embodiment, remote device 54 is an Internet server or other network server that is controlled by a trusted entity, such as the manufacturer of the vehicle or the vehicle dealership, and communicates with the VCS 52 to retrieve diagnostic or user created information for the vehicle, to provide instructions regarding the operation of the vehicle, or to provision the vehicle with additional features or functionalities. The creation of a secure connection between remote device 54 and VCS 52 involves a handshake procedure in which remote device 54 transmits one or more digital certificates to VCS 52. In one embodiment, the secure connection comprises a Transport Layer Security (TLS) session requiring remote device 54 to provide VCS 52 with one or more public key certificates as further described below with regard to FIGS. 3 and 4. Remote device 54 includes a processor 120, memory 122, and a network interface 124. Network interface 124 enables remote device 54 to communicate with other electronic devices (e.g., subordinate certificate authority 58 and the VCS 52) via the electronic network 61.

Prior to establishing a secure connection with VCS 52, remote device 54 receives a first sub-CA certificate and a first remote device certificate from a subordinate certificate authority (e.g., the subordinate certificate authority 58). As described above, the first sub-CA certificate includes a sub-CA public key for the subordinate certificate authority, a serial value, and a digital signature generated with the CA private key. In addition, the first remote device certificate includes a remote device public key that mathematically corresponds to a remote device private key stored in memory 122, and a digital signature. These certificates may be received via the electronic network 61 or by other suitable data transfer techniques (e.g., hand delivery).

In addition, Remote device 54 may subsequently receive additional sub-CA certificates and additional remote device certificates from other subordinate certificate authorities. For example, if subordinate certificate authority is compromised, remote device 54 will receive an additional sub-CA certificate and remote device certificate from another subordinate certificate authority. Each additional sub-CA certificate will include a sub-CA public key for the subordinate certificate authority, a serial value, and a digital signature generated with the CA private key. In addition, each additional remote device public key includes the public key for the remote device and a digital signature generated with the private key of the subordinate certificate authority.

Remote device 54 utilizes the most recently received sub-CA certificate and remote device certificate to establish the secure connection with VCS 52. The most recently received sub-CA certificate and remote device certificate will be referred to herein as the current sub-CA certificate and the current remote device certificate, respectively.

During the handshake procedure, remote device 54 always transmits the current remote device certificate to VCS 52. However, remote device 54 only transmits the current sub-CA certificate to VCS 52 if it determines that VCS 52 has not yet received the current sub-CA certificate. Thus, the amount of information transmitted between VCS 52 and remote device 54 during the handshake procedure is substantially reduced because remote device only transmits each sub-CA certificate one time.

Processor 120 is configured to store data in memory 122 identifying the last-sub CA certificate that was transmitted to VCS 52. For example, processor 120 may store the serial value for the last sub-CA certificate transmitted to VCS 52. During the handshake procedure, processor 120 compares the serial value for the current sub-CA certificate with the serial value that is stored in memory 122 to determine if the current sub-CA certificate was issued after the time that the last sub-CA certificate transmitted to VCS 52 was issued. If there is no serial value stored in memory 122, processor 120 determines that VCS 52 has not previously received a sub-CA certificate (e.g., because VCS 52 and remote device 54 have not previously communicated). Further, if the serial value for the current sub-CA certificate is greater than the stored serial value, processor 120 determines that the current sub-CA certificate is newer than the last sub-CA certificate transmitted to VCS 52. In both cases, processor 120 stores the serial value for the current sub-CA certificate in memory 122 (and deletes the previous serial value if necessary) and transmits the current sub-CA certificate along with the current remote device certificate during the handshake procedure.

Alternatively, if the serial value for the current sub-CA certificate is equal to the stored serial value, processor 120 determines that VCS 52 has already received the current sub-CA certificate. In this case, processor 120 transmits only the remote device public key certificate to VCS 52 during the handshake procedure.

Thus, remote device 54 transmits each sub-CA certificate to VCS 52 only during the next handshake procedure after the sub-CA certificate is received. As long as remote device 54 does not receive a newer sub-CA certificate, remote device 54 transmits only the current remote device certificate for every subsequent handshake procedure. However, if remote device 54 does receive a newer sub-CA certificate, it transmits both the newer sub-CA certificate and remote device certificate during the next subsequent handshake procedure.

VCS 52 is configured to establish a plurality of secure connection with remote device 54. As depicted, and as described above, VCS 52 includes a processor 130, memory 132, and a wireless transceiver 134, and an antenna 136. Wireless transceiver 134 and antenna 136 enable the VCS 52 to communicate with the remote device 54 via the electronic network 61. It should be noted that although the illustrated embodiment comprises a VCS 52 that establishes a secure connection with the remote device 54, alternative embodiments of the present invention may comprise other electronic devices, such as a laptop, a PDA, a cell phone, or any other device that is capable of establishing a secure connection with the remote device 54 via electronic network 61.

Prior to establishing a secure connection, VCS 52 receives the root certificate from trusted root certificate authority 56. As described above, in one embodiment the root certificate is stored on the VCS 52 during the production process of the vehicle. During the handshake procedure for establishing a secure connection, VCS 52 may receive both a sub-CA certificate and a remote device certificate from remote device 54. This case is described below with regard to FIG. 3 typically occurs during the handshake for the first secure connection between VCS 52 and remote device 54 or when remote device 54 transmits a new sub-CA certificate issued by a different certificate authority. Alternatively, VCS 52 may receive only a remote device certificate from remote device 54. This case is described below with regard to FIG. 4 and will typically occur during handshake procedures that occur after VCS 52 has already received the current sub-CA certificate for the remote device.

FIG. 3 is a flow chart of an exemplary method 300 for receiving a sub-CA certificate and remote device certificate during a handshake procedure for establishing a secure connection. With reference to FIGS. 2 and 3, method 300 is performed by processor 130 for VCS 52 in the case where remote device 54 transmits both a sub-CA certificate and a remote device certificate to VCS 52. As described above, the remote device 54 transmits both the sub-CA certificate and the remote device certificate only when it determines that the VCS 52 has not already received the sub-CA certificate. Typically, this will occur the first time that remote device 54 and VCS 52 establish a secure connection or when remote device 54 receives a new sub-CA certificate and remote device certificate from a subordinate certificate authority.

During step 302 of method 300, processor 130 determines if there is already a sub-CA certificate that corresponds to remote device 54 stored in memory 132. If it is able to identify a stored sub-CA certificate, processor 130 continues to step 304. In this case, remote device 54 and VCS 52 have previously established a secure connection with one another and processor 130 stored a copy of the sub-CA certificate received during that handshake and associated it with remote device 54. Alternatively, if processor 130 determines that there is not sub-CA certificate associated with remote device 54 in memory 132, then it proceeds to step 306. In this case, remote device 54 and VCS 52 may be establishing a secure connection with one another for the first time.

During step 304, processor 130 determines if the serial value in the received sub-CA certificate is greater than the serial value in the stored sub-CA certificate. If the serial value for the received sub-CA certificate is greater than or equal to the serial value for the stored sub-CA certificate, processor 130 determines that the received sub-CA is newer than, or the same as, the stored sub-CA certificate and proceeds to step 306. Alternatively, if the serial value for the received sub-CA certificate is less than the serial value for the stored sub-CA certificate, the received sub-CA certificate is not newer than the stored sub-CA certificate and should be transmitted by remote device 54. In this case, processor 130 generates an error (step 308).

During step 306, processor 130 determines if the received sub-CA certificate was issued by trusted root certificate authority 56. During this step processor 130 retrieves the CA public key from the root certificate stored in memory 132. Processor 130 then attempts to authenticate the digital signature stored within the received sub-CA certificate using the CA public key. If processor 130 authenticates the digital signature, then it determines that trusted root certificate authority 56 issued the received sub-CA certificate and that the sub-CA public key stored within the received sub-CA certificate corresponds to a trusted subordinate certificate authority 58. In this case, processor 130 proceeds to step 310. Alternatively, if processor 130 is not able to authenticate the digital signature, then it determines that trusted root certificate authority 56 did not issue the received sub-CA certificate. In this case, processor 130 generates an error (step 308).

During step 310, processor 130 determines if the received remote device certificate was issued by the trusted subordinate certificate authority 58. During this step, processor 130 attempts to authenticate the digital signature stored within the received remote device certificate with the sub-CA public key from the received sub-CA public key certificate. If processor 130 is not able to authenticate the digital signature, it generates an error (step 308). Alternatively, if processor 130 is able to authenticate the digital signature, then it determines that the trusted subordinate certificate authority 58 issued the received remote device certificate and that the remote device public key stored within the received remote device certificate corresponds to a trusted remote device 54. In this case, processor 130 proceeds to step 312.

During step 312, processor 130 stores the received sub-CA certificate in memory 132 for subsequent use in verifying the authenticity of remote device certificate received from remote device 54 (as described below with regard to FIG. 4). Processor 130 also associates the received sub-CA certificate with remote device 54. In some embodiments, processor 130 only stores the received sub-CA certificate in memory 132 if the received sub-CA certificate is different than the stored sub-CA certificate. Finally, if there is another sub-CA certificate stored in memory 132 and associated with remote device 54, processor 130 deletes it during step 312. Upon the completion of step 312, processor 130 continues performing the handshake procedure for establishing a secure connection with remote device 54 (step 314).

FIG. 4 is a flow chart of an exemplary method for receiving only a remote device certificate during a handshake procedure for establishing a secure connection. With reference to FIGS. 2 and 4, method 400 is performed by processor 130 for VCS 52 in the case where remote device 54 transmits only a remote device certificate to VCS 52. As described above, this will typically occur when remote device 54 determines that VCS 52 has already received a copy of the sub-CA certificate that is necessary to authenticate the remote device certificate.

During step 402, processor 130 determines if there is a sub-CA certificate stored in memory 132 that is associated with remote device 54. If processor 130 determines that there is a stored sub-CA certificate it continues to step 404. In this case, remote device 54 and VCS 52 have previously established a secure connection with one another and processor 130 stored a copy of the sub-CA certificate used during the handshake procedure for that connection. The stored sub-CA certificate was authenticated during the previous handshake procedure and there is no need to authenticate it again. Alternatively, if processor 130 determines that there is not sub-CA certificate associated with remote device 54 stored in memory 132, then processor 130 generates an error (step 406).

During step 404, processor 130 determines if the received remote device certificate was issued by the subordinate certificate authority that corresponds to the stored sub-CA certificate. Processor 130 retrieves the sub-CA public key from the stored sub-CA certificate and uses the sub-CA public key to attempt to authenticate the digital certificate stored within the received remote device certificate with the sub-CA public key. If processor 130 is able to authenticate the digital signature, it continues with the handshake procedure (step 408). If processor 130 is not able to authenticate the digital signature, it generates an error (step 406).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for verifying on an electronic device that a remote device is a trusted entity, the method comprising:
receiving a first digital certificate at the electronic device, wherein the first digital certificate corresponds to a first certificate authority and the first certificate authority is a trusted entity;
receiving a second digital certificate at the electronic device, wherein the second digital certificate corresponds to a second certificate authority and is received from the remote device during a handshake procedure for establishing a secure connection;
determining if the second digital certificate was issued by the first certificate authority based on at least a portion of the contents of the first digital certificate; and
storing the second digital certificate to enable subsequent authentication of additional digital certificates received from the remote device, if the second digital certificate was issued by the first certificate authority.

2. The method of claim 1, wherein the storing step further comprises associating the second digital certificate with the remote device.

3. The method of claim 1, further comprising:
receiving a third digital certificate at the electronic device, wherein the third digital certificate corresponds to, and is received from, the remote device;
determining if the third digital certificate was issued by the second certificate authority based on at least a portion of the contents of the second digital certificate.

4. The method of claim 3, wherein
the step of receiving the third digital certificate further comprises receiving the third digital certificate from the remote device during the first handshake procedure; and
the step of storing further comprises storing the second digital certificate if the third digital certificate was issued by the second certificate authority.

5. The method of claim 3, wherein:
the step of receiving the third digital certificate further comprises receiving the third digital certificate during a subsequent handshake procedure; and
the step of determining further comprises retrieving the stored second digital certificate.

6. The method of claim 3, further comprising:
continuing the first handshake procedure for establishing the secure connection if the second digital certificate was issued by the first certificate authority and the third digital certificate was issued by the second certificate authority.

7. The method of claim 4, wherein the second digital certificate comprises a first value and the method further comprises:
receiving a fourth digital certificate at the electronic device during a second handshake procedure for establishing a secure connection, wherein the fourth digital certificate corresponds to a third certificate authority, comprises a second value, and is received from the remote device;
receiving a fifth digital certificate at the electronic device during the second handshake procedure, wherein the fifth digital certificate corresponds to, and is received from, the remote device;
determining if the fourth digital certificate was issued by the first certificate authority based on at least a portion of the contents of the first digital certificate, if the second value is greater than or equal to the first value;
determining if the fifth digital certificate was issued by the third certificate authority based on at least a portion of the contents of the fourth digital certificate, if the second value is greater than or equal to the first value; and
storing the fourth digital certificate to enable subsequent authentication of additional digital certificates received from the remote device if the fourth digital certificate was issued by the first certificate authority, the fifth digital certificate was issued by the third certificate authority, and the second value is greater than or equal to the first value.

8. The method of claim 7, further comprising:
receiving a sixth digital certificate at the electronic device during a third handshake procedure for establishing a secure connection, the sixth digital certificate corresponding to the remote device;
retrieving the fourth digital certificate; and
determining if the sixth digital certificate was issued by the third certificate authority based on at least a portion of the contents of the fourth digital certificate.

9. A vehicular communication system for establishing a secure connection with a remote device, the vehicular communication system comprising:
a wireless transceiver for communicating with the remote device;
electronic memory having a first digital certificate issued by a first certificate authority stored thereon, wherein the first certificate authority is a trusted entity; and
a processor coupled to the wireless transceiver and the electronic memory and configured to:
receive a second digital certificate from the remote device during a handshake procedure for establishing the secure connection, the second digital certificate corresponding to a second certificate authority;
receive a third digital certificate from the remote device during the handshake procedure, the third digital certificate corresponding to the remote device;
determine if the second digital certificate was issued by the first certificate authority based on at least a portion of the contents of the first digital certificate;
determine if the third digital certificate was issued by the second certificate authority based on at least a portion of the contents of the second digital certificate; and
store the second digital certificate to enable subsequent authentication of additional digital certificates received from the remote device, if the second digital certificate was issued by the first certificate authority and the third digital certificate was issued by the second certificate authority.

10. The vehicular communication system of claim 9, wherein the processor is further configured to:
receive a fourth digital certificate during a second handshake procedure for establishing the secure connection;
retrieve the stored second digital certificate; and
determine if the fourth digital certificate was issued by the second certificate authority based on at least a portion of the contents of the second digital certificate.

11. The vehicular communication system of claim 9, wherein the handshake procedure comprises a handshake procedure for establishing a Transport Layer Security session with the remote device.

12. The vehicular communication system of claim 9, wherein the second digital certificate comprises a first value.

13. The vehicular communication system of claim 12, wherein the processor is further configured to:
receive a fourth digital certificate from the remote device during a second handshake procedure, the fourth digital certificate corresponding to a third certificate authority and comprising a second value;
receive a fifth digital certificate from the remote device during the second handshake procedure, the fifth digital certificate corresponding to the remote device;
determine if the fourth digital certificate was issued by the first certificate authority based on at least a portion of the contents of the first digital certificate, if the second value is greater than or equal to the first value;
determine if the fifth digital certificate was issued by the third certificate authority based on at least a portion of the contents of the fourth digital certificate, if the second value is greater than or equal to the first value; and
store the fourth digital certificate, if the fourth digital certificate was issued by the first certificate authority, the fifth digital certificate was issued by the third certificate authority, and the second value is greater than the first value.

14. The vehicular communication system of claim 13, wherein the processor if further configured to:
receive a sixth digital certificate from the remote device during an a third handshake procedure;
retrieve the fourth digital certificate; and
determine if the sixth digital certificate was issued by the third certificate authority based on at least a portion of the contents of the stored fourth digital certificate.

15. An electronic device for establishing a secure connection with a mobile device, the electronic device comprising:
an electronic communication interface;
electronic memory for storing data describing digital certificates previously transmitted to the mobile device;
a processor coupled to the electronic communication interface and configured to:
receive a first digital certificate from a subordinate certificate authority, the first digital certificate corresponding to the subordinate certificate authority and issued by a root certificate authority;
receive a second digital certificate from the subordinate certificate authority, the second digital certificate corresponding to the electronic device and issued by the subordinate certificate authority;
determine if the first digital certificate was previously transmitted to the mobile device, based on the data stored in the electronic memory;
transmit the first digital certificate and the second digital certificate to the mobile device during a handshake procedure for establishing a secure connection, if the first digital certificate has not been transmitted to the mobile device; and
store data in the electronic memory indicating that the first digital certificate was transmitted to the mobile device.

16. The electronic device of claim 15, wherein the processor is further configured to transmit only the second digital certificate during a subsequent handshake procedure if the stored data indicates that the first digital certificate was previously transmitted to the mobile device previously.

17. The electronic device of claim 16, wherein the first digital certificate comprises a first value and the processor is further configured to:
determine if the first digital certificate was previously transmitted to the mobile device by comparing the first value to a previous value stored in the electronic memory;
transmit the first digital certificate and the second digital certificate to the mobile device during the handshake procedure if the first value is greater than the previous value; and
store the first value in memory if the first value is greater than the previous value.

18. The electronic device of claim 17, wherein the processor is further configured to:
receive a third digital certificate from a third certificate authority, wherein the third digital certificate corresponds to the third certificate authority, is issued by the root certificate authority, and comprises a second value;
receive a fourth digital certificate from the third certificate authority, wherein the fourth digital certificate corresponds to the electronic device and is issued by the third certificate authority;
transmit the third digital certificate and the fourth digital certificate to the electronic device if the second value is greater than the stored first value; and
store the second value in the electronic memory.

19. The electronic device of claim 18, wherein the processor is further configured to transmit the fourth digital certificate to the electronic device during a subsequent handshake procedure for establishing a secure connection.

20. The electronic device of claim 18, wherein the mobile device comprises a vehicular communication system.
